(19) United States
(12) Patent Application Publication
(10) Pub. No.: US 2008/0175425 A1
(43) Pub. Date: Jul. 24, 2008

(54) Microphone System with Silicon Microphone Secured to Package Lid

(75) Inventors: Carl M. Roberts, Topsfield, MA (US); Kieran P. Harney, Andover, MA (US); Alvin Grusby, Newton, MA (US); Dipak Sengupta, Boxboro, MA (US); Richard J. Sullivan, Salem, MA (US)

Correspondence Address: BROMBERG & SUNSTEIN LLP, 125 SUMMER STREET, BOSTON, MA, 02110-1618, US

(73) Assignee: ANALOG DEVICES, INC., Norwood, MA (US)

(21) Appl. No.: 11/947,192

(22) Filed: Nov. 29, 2007

Related U.S. Application Data
(60) Provisional application No. 60/861,809, filed on Nov. 30, 2006.

(51) Int. Cl. H04R 11/04

(52) U.S. Cl. 381/361

(57) ABSTRACT

A microphone system has a base with at least one electrical port for electrically communicating with an external device. The system also has a solid metal lid coupled to the base to form an internal chamber, and a silicon microphone secured to the lid within the chamber. The lid has an aperture for receiving an audible signal, while the microphone is electrically connected to the electrical port of the base.

### PRIORITY

This patent application claims priority from provisional U.S. patent application No. 60/861,809, filed Nov. 30, 2006, entitled, “MICROPHONE SYSTEM WITH MICROPHONE COUPLED TO PACKAGE APERTURE,” and naming Carl M. Roberts and Kieran P. Harney as inventors, the disclosure of which is incorporated herein, in its entirety, by reference.

### FIELD OF THE INVENTION

The invention generally relates to microphones and, more particularly, the invention relates to packaged microphones

### BACKGROUND OF THE INVENTION

MEMS microphones typically are secured within a package to protect them from the environment. Many such packages often have a base for supporting the microphone, and a lid secured to the base. One or more apertures through some portion of the package permits audio signals to reach the microphone. Receipt of the audio signal causes the microphone to produce an electronic signal representing the audio qualities of the received signal.

There may be instances where sound passing through the aperture does not directly impact the microphone. In such case, the microphone generally may not respond as desired, thus not appropriately reproducing a received audio signal.

### SUMMARY OF THE INVENTION

In accordance with one aspect of the invention, a microphone system has a base with at least one electrical port for electrically communicating with an external device. The system also has a solid metal lid coupled to the base to form an internal chamber, and a silicon microphone secured to the lid within the chamber. The lid has an aperture for receiving an audible signal, while the microphone is electrically connected to the electrical port of the base.

Some embodiments secure the microphone about the aperture. Alternative embodiments also secure the microphone also to the base. In that case, among other ways, a bump may secure the microphone to the base and at least in part electrically connect the microphone with the electrical port of the base. In addition, a low modulus epoxy may secure the lid to the base. The base may be one of a variety of different types of package bases, such as a substrate package base, laminate package base, or a leadframe base.

Moreover, the system may also have a chip (e.g., an application specific integrated circuit) secured within the chamber, where the chip electrically communicates with the microphone. The chip and microphone may be spatially related in a number of different manners. For example, the chip and microphone may be in a stacked configuration (e.g., one on top of the other) or in a side-by-side configuration. In other embodiments, the microphone and chip are integrated on a single chip.

The system may couple with a number of different types of external devices, such as a printed circuit board that physically and electrically connects to the electrical port of the base. In illustrative embodiments, the base has an inner surface forming the chamber, and an outer surface opposite the inner surface. In that embodiment, the electrical port may be located on the outer surface of the base (e.g., it may effectively form part of the outer surface of the base).

In accordance with another embodiment of the invention, a microphone system has a package that contains a silicon microphone. Specifically, the package may be formed from a base coupled with a solid metal lid that together form an internal chamber. The lid has an aperture for receiving an audible signal. The silicon microphone illustratively is secured to the lid within the chamber. In this embodiment, the microphone may be connected about the aperture.

In accordance with other embodiments of the invention, a method of forming a microphone system provides a solid metal lid with an aperture, secures the solid metal lid to a base to form an interior chamber, and secures a silicon microphone about the aperture within the interior chamber. This process may or may not necessarily be carried out in this order. For example, the microphone may be secured about the aperture before securing the lid and the base, or at about the same time that the lid and base are secured together.

In accordance with another embodiment, a microphone system has a base with at least one electrical port for electrically communicating with an external device, and a lid coupled to the base. The lid and base together form an internal chamber. The system also has a silicon microphone secured to the lid within the chamber, and an electrical connector extending through the interior chamber to contact the base. The electrical connector electrically connects the microphone to the electrical port of the base.

Unlike some prior noted embodiments, this embodiment is not necessarily limited to a solid metal lid. For example, this embodiment may have a lid formed with electrical interconnects (e.g., a printed circuit board). In illustrative embodiments, the electrical connector comprises a bump/ball formed from solder or some other material.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a perspective view of a microphone system that may be configured in accordance with illustrative embodiments of the invention.

FIG. 2A schematically shows a first cross-sectional view of the microphone of FIG. 1 configured in accordance with a first embodiment of the invention.

FIG. 2B schematically shows a first cross-sectional view of the microphone of FIG. 1 configured in accordance with a second embodiment of the invention.

FIG. 2C schematically shows a first cross-sectional view of the microphone of FIG. 1 configured in accordance with a third embodiment of the invention.

FIG. 2D schematically shows a first cross-sectional view of the microphone of FIG. 1 configured in accordance with a fourth embodiment of the invention.

FIG. 3 shows a first process of forming the microphone of FIG. 1 in accordance with one embodiment of the invention.

### DESCRIPTION OF ILLUSTRATIVE EMBODIMENTS

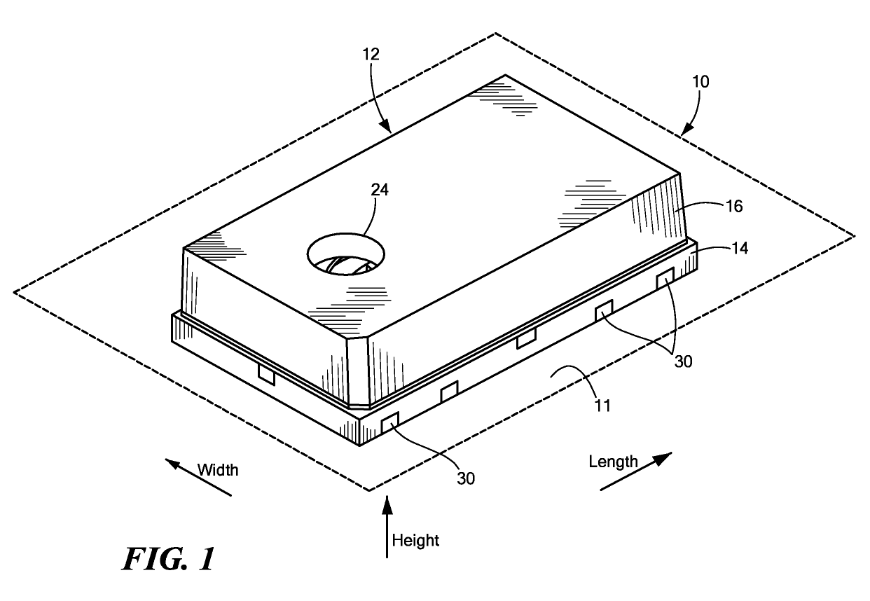

Prior art top port, metal lid, silicon based microphones known to the inventors have a number of drawbacks. As background, those in the art typically mount a packaged silicon microphone to an underlying device, such as a circuit board within a cellular telephone. The port for receiving audio signals (of a top port microphone) typically faces upwardly, away from the underlying device (i.e., in the example, away from the printed circuit board, as shown in FIG. 1, discussed below). Accordingly, the port of a top port microphone does not face the underlying device to which it is mounted.

Some prior art top port microphone designs known to the inventors mount a silicon microphone over an aperture on a circuit board-type package substrate, and cover the microphone by securing a metal lid to the substrate. During use, such a design is flipped upside down onto an underlying apparatus, such as a circuit board within a cellular telephone. Undesirably, when using this arrangement, the metal lid faces the mounting surface of the underlying circuit board. As such, its metal lid limits the available area for electrically coupling with the circuit board (i.e., bond pads are limited to areas not covered by the lid). To avoid this problem, some prior art devices sacrifice the more effective electromagnetic interference (EMI) protection of a metal lid and, instead, use a package substrate of circuit board material both above and below the microphone.

Illustrative embodiments avoid these and other problems by retaining the metal lid and mounting a silicon microphone directly to its underside—preferably over the aperture in the lid. Accordingly, such embodiments do not limit the bond pad locations of the substrate/base, thus providing significant flexibility for mounting to a variety of underlying devices (e.g., circuit boards within cellular telephones). In addition, such embodiments should provide a more effective EMI shield than those that do not use a metal lid while, at the same time, maximizing the microphone back volume.

As discussed below, however, this configuration creates additional difficulties, which the inventors overcame; namely, electrically connecting the microphone to electrical pads in the base. Details of how the inventors overcame these difficulties and related embodiments are discussed below.

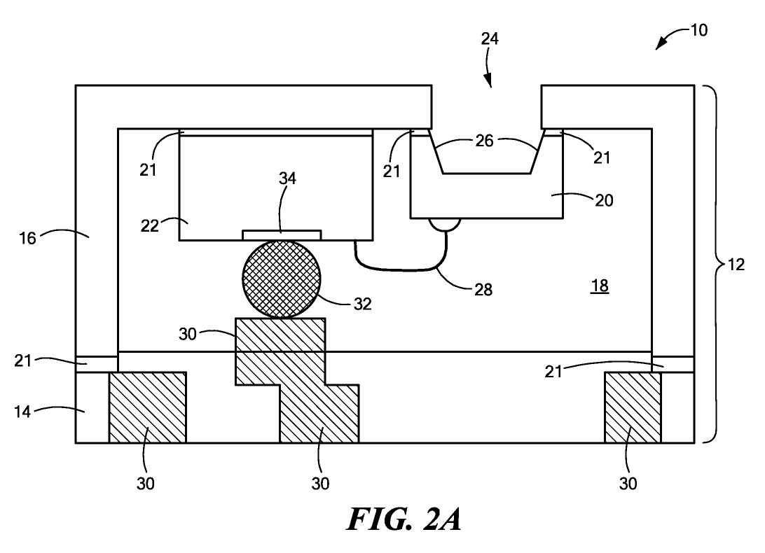

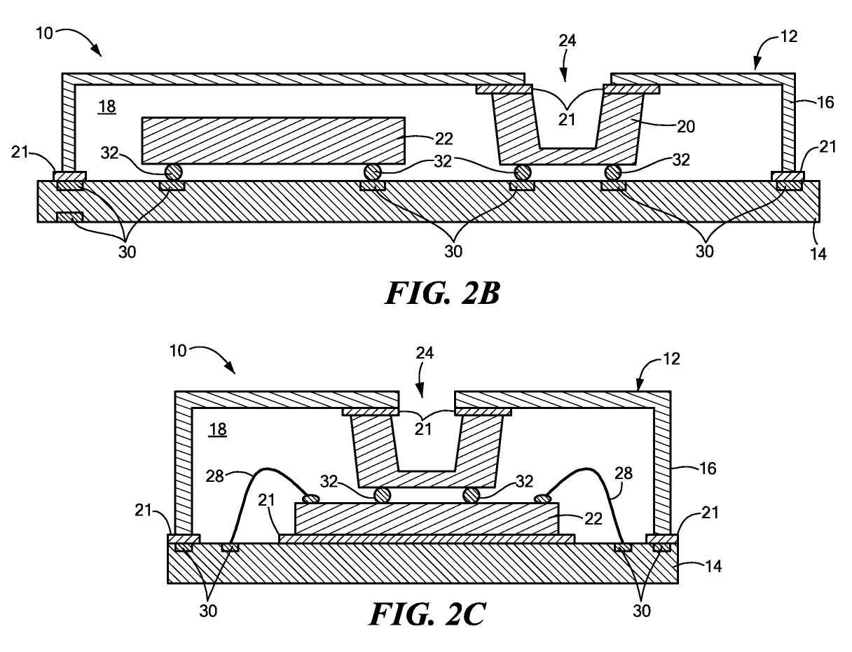

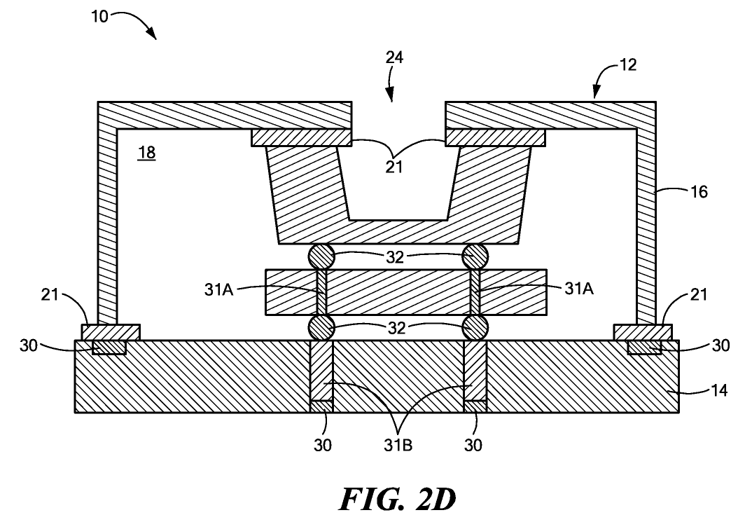

FIG. 1 schematically shows a microphone system 10 implemented in accordance with illustrative embodiments of the invention. FIGS. 2A-2D schematically show cross-sectional views of the same microphone system 10 in a variety of different configurations.

The microphone system 10 has a package 12 coupled with an underlying apparatus 11, such as a printed circuit board 11. The underlying apparatus 11, however, can comprise any of a variety of other devices. Accordingly, discussion of a printed circuit board is illustrative and not intended to limit a variety of other embodiments.

The package 12 has a base 14 that, together with a corresponding metal lid 16, forms an interior chamber 18 containing a MEMS/silicon microphone chip 20 and circuit chip 22 (e.g., an application specific integrated circuit). The primary function of the circuit chip 22 is to control and manage input to and output from the microphone chip 20. For example, among other things, a circuit chip 22 may amplify varying capacitance signals produced by the microphone chip 20, and control the voltage applied to the microphone chip 20. In illustrative embodiments, the circuit chip 22 is implemented as an application specific integrated circuit, which is also known as an “ASIC.”

The lid 16 in the embodiments shown is a cavity-type, solid metal lid, which has four walls extending generally orthogonally from a top, interior face to form a cavity. As a solid metal type of lid, the lid 16 is not a metal coating on a plastic or other base material. Instead, illustrative embodiments form a lid from a piece of metal, such as a piece of sheet metal. For example, in illustrative embodiments, the lid 16 is a formed metal lid having a generally cup-shaped concavity defining a part of the package chamber 18. The lid 16 secures to the top face of the substantially flat package base 14 to form the interior chamber 18.

Other types of metal lids may be used. For example, the lid 16 may be flat and coupled to upwardly projecting walls extending from the base 14. The lid 16 also has an audio input port 24 (also referred to as an aperture 24) that enables ingress of audio signals into the chamber 18. In alternative embodiments, however, the audio port 24 is at another location, such as through another portion of the top face of the lid 16, the side of the lid 16, or even through the base 14.

Audio signals entering the interior chamber 18 interact with the microphone chip 20 and, consequently, the circuit chip 22, to produce an electrical signal. As shown in FIG. 1, the bottom face of the package base 14 has a number of external contacts/bond pads 30 for electrically (and physically, in many anticipated uses) connecting the microphone system 10 with a substrate (not shown), such as a printed circuit board 11 or other electrical interconnect apparatus. In illustrative embodiments, the package 12 is surface mounted to the circuit board 11. Accordingly, during use, the microphone chip 20 and circuit chip 22 converts audio signals received through the aperture 24 into electrical signals, and route those signals through external contacts/bond pads 30 in the base 14 to the circuit board 11.

In illustrative embodiments, the package base 14 is formed from an electrical interconnect apparatus, such as a ceramic package material, carrier, printed circuit board material (e.g., using alternating layers of FR-4 or a BT-resin/epoxy laminate-type material). Other types of packages may be used, however, such as premolded, leadframe-type packages (also referred to as a “premolded package”). As suggested above, the base 14 may be a cavity package, or a flat-type package.

In accordance with illustrative embodiments of the invention, as shown in FIGS. 2A-2D, the microphone chip 20 is mounted within the chamber 18 about the aperture 24. More specifically, the microphone chip 20 is considered to have a periphery 26. This periphery 26 may be continuous, or discontinuous. Accordingly, to be coupled to, over, under, or about the aperture 24 (whichever term is used), the microphone chip periphery 26 substantially circumscribes at least a portion of the aperture 24. Of course, if discontinuous, the periphery 26 does not necessarily circumscribe the entire aperture 24. In that case (as when the periphery 26 is continuous), however, the entire periphery 26 of the microphone chip 20 illustratively is positioned radially outwardly from the aperture 24.

In various embodiments, the package 12 has no more than one aperture 24. Other embodiments, however, may have a plurality of apertures 24. For example, the microphone chip periphery 26 may circumscribe two or more apertures 24. As another example, the package 12 may have additional apertures 24 that may or may not be circumscribed the chip periphery 26.

FIGS. 2A-2D show a variety of different embodiments of the invention. Specifically, FIG. 2A shows a first embodiment in which both the microphone chip 20 and circuit chip 22 directly couple with the lid 16. One or more wirebonds 28 electrically connect the microphone chip 20 to the circuit chip 22. To electrically connect the microphone chip 20 and circuit chip 22 with the substrate, the microphone system 10 also has one or more conductive paths 32 mechanically coupled between the circuit chip 22 and one or more internal contacts 30 on the base 14. Among other things, the conductive path 32 may be a solder ball. As shown, the circuit chip 22 may be considered to mechanically connect with both the lid 16 and the base 14. The microphone chip 20, however, is considered to be mechanically connected with the lid 16 only (i.e., and not mechanically connected with the base 14). A conductive epoxy 21 may electrically ground a portion of the microphone chip 20 to the lid 16. For example, if the microphone chip 20 is formed from a silicon-on-insulator wafer, then the conductive epoxy 21 can effectively ground its bottom silicon layer.

FIG. 2B schematically shows a second embodiment of the invention, in which the microphone chip 20 mechanically connects with both the lid 16 and the base 14. To that end, a conductive or nonconductive epoxy 21 may connect the microphone chip 20 with the lid 16, while one or more solder balls connect the same microphone chip 20 with the base 14. The circuit chip 22, however, mechanically connects with the base 14 only—it does not mechanically connect with the lid 16. As shown, in a manner similar to the microphone chip 20, one or more solder balls 32 electrically and mechanically connect between the circuit chip 22 and the base 14. It should be noted, however, that other techniques, such as those discussed for other embodiments, may be used for electrically and mechanically connecting the circuit chip 22 and microphone chip 20 within the package 12. The base 14 therefore provides the means for electrically communicating between the chips 20 and 22.

FIGS. 2A and 2B show embodiments in which the microphone chip 20 and circuit chip 22 are in a “side-by-side” arrangement/configuration. Specifically, as shown by three arrows in FIG. 1, the microphone system 10 is considered to have a length dimension, a width dimension, and a height dimension. It should be noted that although the length dimension typically is greater than the width and height dimensions, the relative sizes of the length, width, and height can vary depending upon the application. Accordingly, the two chips 20 and 22 are considered to be in a side-by-side arrangement because, as shown, they are positioned next to each other along either the width and/or height dimensions. Stated another way, they do not share a vertical plane (i.e., a plane generally parallel with the height dimension).

In contrast, FIGS. 2C and 2D schematically show third and fourth embodiments in which the two chips 20 and 22 are in a stacked configuration. In other words, as shown, the two chips 20 and 22 share at least one vertical plane. For example, the general centers of the two chips 20 and 22 may be substantially aligned.

Specifically, FIG. 2C schematically shows a third embodiment in which the microphone chip 20 mechanically couples with the underside of the lid and the top surface of the circuit chip 22. In turn, the circuit chip 22 mechanically and electrically connects with the base 14 by two separate mechanisms. Specifically, the circuit chip 22 mechanically connects with the base 14 by means of an epoxy 21, and electrically connects with the base 14 by means of wire bonds. Accordingly, although the individual chips 20 and 22 do not connect to both the lid 16 and the base 14, they effectively form a stacked up apparatus that connects with both the lid 16 and the base 14.

FIG. 2D schematically shows another embodiment using a stacked up apparatus, which comprises the two chips 20 and 22. Rather than using separate mechanisms to electrically and mechanically connect with the base 14, this embodiment uses solder bumps/balls 32 both to electrically and mechanically connect the circuit chip 22 with the base 14. This embodiment also shows other features, which may be in other embodiments, such as vias 31A through the base 14, and vias 31B through the circuit chip 22.

Of course, various embodiments of the invention may be implemented using combinations of elements that are not shown in the drawings. For example, some embodiments implement the functionality of both chips 20 and 22 on a single chip-often referred to in the art as an “integrated MEMS.” For example, the microphone chip 20 may have circuitry implemented on its substrate, or in its cap. In other embodiments, the package 12 also may have additional functionality within its interior chamber. For example, the package 12 may contain an inertial sensor (e.g., an accelerometer or gyroscope) in addition to or instead of the circuit chip 22. Accordingly, discussion of the configurations of the specific drawings is for illustrative purposes only.

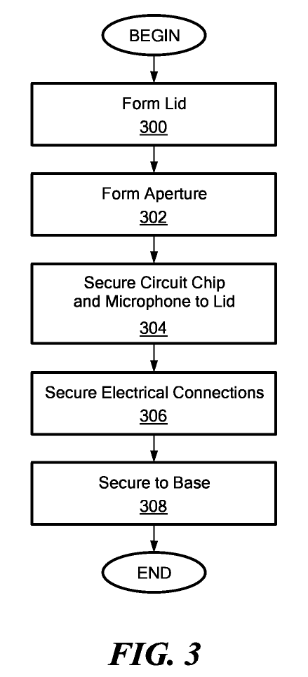

FIG. 3 shows a process of forming the microphone system 10 of FIG. 2A in accordance with illustrative embodiments. It should be noted that this process merely describes one way of forming the microphone system 10 of FIG. 2A. Those skilled in the art may modify some steps and/or change the order of the steps to some extent. In fact, actual implementation may require more steps (e.g., testing steps), omit certain steps, a change to the order of some steps, and/or merge steps and still fall within the scope of various embodiments. The steps in this process therefore are generalizations of a microphone production process that may be used. In addition, the process is discussed as if only one microphone system 10 is being produced. It is anticipated that during production, batch processes may simultaneously produce multiple microphone systems in a single automated process.

The process of FIG. 3 begins at step 300, which forms the metal lid 16. To that end, illustrative embodiments may produce a formed metal lid 16, among other types, in accordance with conventional processes. As noted above, this lid 16 may have four walls, or be generally cup-shaped, to form an interior cavity. To that end, various embodiments use progressive stamping and forming techniques to from the cavity in the lid 16.

After forming the lid 16, the process may form the aperture 24 (step 302). The aperture 24 may take on any of a variety of shapes, such as a circular or rectangular shape. The process then secures the circuit chip 22 and microphone chip 20 to the interior side of the lid 16 (step 304). In illustrative embodiments, as discussed above, the process connects the microphone chip 20 directly over the aperture 24. Among other benefits, this connection maximizes the ultimate size of the back volume for the microphone chip 20 (within the chamber 18), thus permitting an improved sensitivity and generally flat frequency response. Alternative embodiments, however, may connect the microphone chip 20 to another part of the lid interior (i.e., not over the aperture 24. Such an embodiment is not shown in the drawings.).

An appropriate conventional chip connection means, such as a conductive or nonconductive epoxy 21, may connect the chip 20 and 22 with the lid 16. Illustrative embodiments connect the circuit chip 22 with a low modulus epoxy. Such epoxy 21 may be selected as required by the application. It is anticipated that epoxies having moduli below about 0.5 GPa should suffice. This specific range of moduli, however, is not intended to limit various embodiments of the invention. Instead, it is mentioned merely as an example to provide an appropriate order of magnitude of moduli. As discussed below, this epoxy 21 facilitates connection of the lid 16 and a base 14.

Step 306 then makes the electrical connections on the circuit chip 22 and microphone chip 20. To that end, the process may secure gold wirebonds, or other types of wirebonds 28, between the circuit chip 22 and microphone chip 20 using conventional techniques.

In addition, the process secures one or more solder balls (identified in the figures by reference number 32) to the various pads 34 on the circuit chip 22. Among other ways, conventional gold stud bumping processes or under-bump metallization processes may be employed. By way of example, if the circuit chip 22 has five pads 34 that communicate with five corresponding contacts 30 on the base 14, then the process may form one solder ball 32 on each pad 34, or two solder balls 32 on each pad 34. The total number of solder balls 32 used depends on the process used. In either case, the number of solder balls 32 per pad 34, and the size of the solder balls 32, must be selected so that when the lid 16 is secured to the base 14, the solder balls 32 contact the appropriate contacts 30 on the base 14. It is anticipated that two solder balls 32 may be more appropriate when using gold stud bumping processes. The solder balls 32 at least in part form an electrical connection between the chips 20 and 22 and the base 14.

After making the electrical connections, the process concludes at step 308, which secures the lid 16 to the base 14. This step is complicated by the fact that the stacked up solder ball 32 and circuit chip 22 must be long enough to electrically and physically contact the contact 30, and yet not be so long that it prevents the lid 16 from securing/registering to the base 14.

To that end, a conductive epoxy having a low modulus of elasticity first may be applied to the periphery of the lid 16 and/or base 14. Some embodiments also add a gasket (e.g., a conductive material or rubber) to the connection point between the lid 16 and microphone chip 22. This forms an acoustic seal between the lid 16 and microphone chip 22. Next, the lid 16 and base 14 may be placed in contact near their peripheries to mechanically secure the two pieces 14 and 16 together, thus forming the package 12 and interior chamber 18. Among other attachment methods, the walls of the lid 16 may be secured on the face of the base 14.

This mechanical connection also electrically connects the lid 16 to contacts 30 the base 14. By doing this, the lid 16 is grounded, thus effectively providing some level of protection from electromagnetic interference (EMI). In addition, as noted above, this connection directly contacts the solder balls 32 with the appropriate contacts 30 of the base 14, thus electrically connecting the microphone chip 20 and circuit chip 22 with the base 14.

Of significance is use of the low modulus epoxy 21. Specifically, use of a sufficiently low modulus epoxy 21 enables the physical components to have some dimensional tolerances, thus overcoming the complication noted above. More particularly, the walls of the lid 16, as well is the stack up of the solder bump 32 and circuit chip 22, may be sized within a tolerance of plus or minus some number of millimeters. The epoxy 21 therefore should be the flexible/soft enough to compensate for such a potential variation in size.

For example, when the lid 16 and base 14 are connected, the solder bump 32 and microphone circuit chip 34 may be sized, within tolerances, so that the lid walls do not fully contact with the base 14. Accordingly, this condition create a small gap between the lid 16 and the base 14 at the intended point of contact. It is anticipated that a sufficient amount of the epoxy 21 should still effectively make the connection between the lid 16 and the base 14. For example, the softness of the low modulus epoxy 21 connecting the circuit chip 22 may yield some space through compression, while the epoxy 21 at the joint of the lid 16 and base 14 should effectively make the connection.

A similar process may be used to form the embodiments shown in FIGS. 2B-2D. Specifically, with reference to the embodiments of FIGS. 2B and 2D, rather than securing the circuit chip 22 and microphone chip 22 to the lid 16 at step 304, these embodiments may first secure those components to the base 14. The lid 16 and base 14 thus are adhered together at some point after securing the chips 20 and 22 to the base 14. In addition, adhering the chips 20 and 22 to the base 14 also makes the effective electrical connections. Accordingly, such embodiments do not require step 306, which secures electrical connections.

Unlike the embodiment of FIG. 2B, however, the embodiment of FIG. 2D first may connect the chips 20 and 22 together in a stacked configuration, and then connect the stacked apparatus to the base 14. Alternatively, this embodiment first may connect the circuit chip 22 to the base 14, and then connect the microphone chip 22 with the appropriate pads of the circuit chip 22. In either case, both chips 20 and 22 either are directly or indirectly secured to the base 14 before securing the lid 16 (as shown).

The embodiment shown in FIG. 2C, which also shows a stacked configuration, may be connected within the package 12 in a manner similar to the method described above with regard to FIG. 2D. This embodiment may retain step 306, however, by using wire bonds to electrically connect the stacked apparatus with the base 14.

Accordingly, various embodiments permit the microphone chip 20 to be mounted to a metal lid, while connecting with an external device through the opposite side of the package; namely through the base 14. Embodiments of this arrangement provide a number of performance advantages for top port microphones. Specifically, among other things, illustrative embodiments permit an electrical connection between the microphone chip 20 and essentially any spot on the bottom side of the base 14 (i.e., the bottom side is the side of the base 14 that is not part of the chamber 18).

This should also enables a direct surface mounted connection to any convenient location on an underlying device, such as a printed circuit board of an electronic apparatus (e.g., a cellular telephone). This mounting technique also should effectively eliminate any requirement for using wirebonds for that purpose. As a result, the microphone system 10 favorably should have a smaller profile within the underlying apparatus. Unlike prior art known to the inventors, various embodiments of the invention deliver this advantage while providing significant electromagnetic interference shielding (i.e., by using a metal lid 16 rather than a metalized substrate or coating).

In addition, various embodiments also improve the flexibility in sizing the package. Specifically, a stacked configuration provides a smaller footprint, while a side-by-side configuration provides a thinner profile. Either option may be selected based upon the application. Moreover, embodiments mounting the microphone chip 20 over the aperture 24 should improve performance by maximizing microphone back volume.

Another problem with prior art top port microphones having electrical interconnects in their lid (e.g., using printed circuit board as a lid) is the long electrical pathway required to electrically connect the microphone with the base. In particular, this electrical pathway extends along the lid, down the sidewalls, and to the base. Undesirably, such a long pathway can create parasitic capacitances that, if large enough, may swamp the small varying capacitance of the microphone itself.

Illustrative embodiments avoid this problem by making a direct electrical connection within the chamber 18 itself. Specifically, in some embodiments, the bumps 32 provide a short electrical connection between one or both of the chips 20 and 22. The parasitic capacitance of such a connection thus should be correspondingly much less than those produced by the noted prior art system, thus reducing the possibility of its parasitics from swamping the microphone signal. Related embodiments may provide this direct, through-chamber connection by some means other than bumps/balls 32.

In fact, some related embodiments of the invention may forego the solid metal lid 16. Instead, such embodiments may have a lid 16 formed from packaging with electrical interconnects, such as those discussed above that may be used for the base 14 (e.g., a printed circuit board, ceramic, FR-4, laminates, etc. . . . ).

Although the above discussion discloses various exemplary embodiments of the invention, it should be apparent that those skilled in the art can make various modifications that will achieve some of the advantages of the invention without departing from the true scope of the invention.

What is claimed is:

1. A microphone system comprising:
a base having at least one electrical port for electrically communicating with an external device;
a solid metal lid coupled to the base, the lid and base forming an internal chamber, the lid having at least one aperture for receiving an audible signal; and
a silicon microphone secured to the lid within the chamber, the microphone being electrically connected to the electrical port of the base.

2. The microphone system as defined by claim 1 wherein the microphone is secured about at least one aperture.

3. The microphone system as defined by claim 1 wherein the microphone also is secured to the base.

4. The microphone system as defined by claim 3 wherein a bump secures the microphone to the base and at least in part electrically connects the microphone with the electrical port of the base.

5. The microphone system as defined by claim 3 wherein a low modulus epoxy secures the lid to the base.

6. The microphone system as defined by claim 1 wherein the base comprises a substrate package base or a laminate package base.

7. The microphone system as defined by claim 1 further comprising a chip secured within the chamber, the chip electrically communicating with the microphone.

8. The microphone system as defined by claim 7 wherein the chip and microphone are in a stacked configuration.

9. The microphone system as defined by claim 7 wherein the chip and microphone are in a side-by-side configuration.

10. The microphone system as defined by claim 1 wherein the external device comprises a printed circuit board that is physically and electrically connected to the electrical port of the base.

11. The microphone system as defined by claim 1 wherein a bump electrically connects the silicon microphone with the base.

12. A top port microphone system comprising:
a package comprising a base coupled with a solid metal lid, the lid and base forming an internal chamber, the lid having at least one aperture for receiving an audible signal; and
a silicon microphone secured to the lid within the chamber, the microphone being connected about at least one aperture.

13. The microphone system as defined by claim 12 wherein the base has an inner surface and an outer surface, the inner surface at least in part of forming the chamber, the outer surface having an electrical port for communicating with an external device, the microphone being electrically connected with the electrical port.

14. The microphone system as defined by claim 13 further comprising a bump that physically connects the microphone with the base, the bump also at least in part electrically connecting the microphone with the electrical port.

15. The microphone system as defined by claim 12 wherein the microphone also is secured to the base.

16. The microphone system as defined by claim 12 wherein a low modulus epoxy secures the lid to the base.

17. A method of forming a microphone system, the method comprising:
providing a solid metal lid with at least one aperture;
securing the solid metal lid to a base to form an interior chamber; and
securing a silicon microphone about the at least one aperture within the interior chamber.

18. The method as defined by claim 17 wherein the act of securing the metal lid secures the silicon microphone about at least one aperture.

19. The method as defined by claim 17 wherein the silicon microphone is secured about at least one aperture before the metal lid is secured to the base.

20. The method as defined by claim 17 further comprising securing the base to a printed circuit board.

21. The method as defined by claim 17 wherein a low modulus epoxy secures the lid to the base.

22. A microphone system comprising:
a base having at least one electrical port for electrically communicating with an external device;
a lid coupled to the base, the lid and base forming an internal chamber;
a silicon microphone secured to the lid within the chamber;
an electrical connector extending through the interior chamber to contact the base, the electrical connector electrically connecting the microphone to the electrical port of the base.

23. The microphone system as defined by claim 22 wherein the lid comprises material having electrical interconnects.

24. The microphone system as defined by claim 22 wherein the lid comprises a solid metal lid.

25. The microphone system as defined by claim 22 wherein the electrical connector comprises a bump mechanically connected with the base.

26. The microphone system as defined by claim 26 wherein the bump extends between the microphone and the base.

27. The microphone system as defined by claim 26 further comprising a chip secured within the chamber, the chip electrically communicating with the microphone, the bump being mechanically connected with the circuit.

28. The microphone system as defined by claim 22 wherein lid forms at least one aperture for receiving audio signals, the microphone being secured over at least one aperture.
